(19) United States
(12) Patent Application Publication
(10) Pub. No.: US 2017/0094354 A1
(43) Pub. Date: Mar. 30, 2017

(54) PROTOCOL FOR GATING ACCESS TO MEDIA ITEMS

(71) Applicant: Apple Inc., Cupertino, CA (US)

(72) Inventors: Roger N. Pantos, Cupertino, CA (US); David L. Biderman, San Jose, CA (US); William B. May, JR., Sunnyvale, CA (US); John Y. Su, Sunnyvale, CA (US); Mohammed Z. Visharam, San Jose, CA (US)

(21) Appl. No.: 14/869,238

(22) Filed: Sep. 29, 2015

(51) Int. Cl. H04N 21/4627; G11B 27/19; H04N 21/438; H04N 21/472; H04N 21/435

(52) U.S. Cl. CPC H04N 21/4627; H04N 21/47217; H04N 21/435; H04N 21/4382; G11B 27/19

(57) ABSTRACT

Methods and systems provide techniques for managing media streaming and content distribution and management using time-based metadata. A video segment may include a gate with associated content that is accessible conditioned on consumption of the gate. The manner in which the gate manages access to the associated content may be defined according to rules and syntactical elements. For example, a gate may be unlocked or collapsed. An unlocked gate allows a user to skip the gate and access the gated content. A collapsed gate is automatically skipped. A gate may become locked or un-collapsed. Various commands, including fast forward, rewind, jump forward, and jump backward may respond to a gate based on its locked or collapsed status. Embodiments also provide pooling of gates and selection of a subset of gates for playing.

### BACKGROUND

The present disclosure relates to multimedia processing. More specifically, it relates to methods and systems for managing content distribution and gating content in a multimedia stream.

Streaming media assets such as audio and/or video streams from a remote server to a client device over a communication network is an increasingly popular way for retrieving and viewing multimedia. In one aspect, a media asset may include an individual multimedia file. In another aspect, a media asset may include a media channel having several multimedia files, which may be rendered in sequence. Media content can be streamed for both Video On Demand (VOD), live TV (LIVE) streaming services, and the like. HTTP Live Streaming (HLS) is one such protocol for transferring streams of media data for such services. Media assets may be retrieved by a client device from one or more distribution servers.

Advertisements may be distributed with the media assets to monetize the content. In traditional broadcasting formats, an “advertisement spot” corresponding to a short time during broadcasting is typically sold to an advertisement provider. VOD and LIVE streaming allows for content to be adapted to audiences more dynamically compared with traditional broadcasting formats. For streaming video, navigation such as playback, fast forwarding, and the like may be conditioned upon viewing at least a portion of an advertisement.

Viewing habits associated with VOD, LIVE streaming, and the like may differ from traditional consumption of multimedia. For example, a user of VOD and LIVE streaming may pause and resume at a later time sometimes on a different device. A user may also provide detailed information about interests, usage habits, etc. based on a client device or user profile. Thus, advertising content for VOD and LIVE streams may be distributed in more sophisticated manners. The inventors perceive a need in the art for collecting information and controlling media playback based on advertisement providers' interest in knowing and/or selecting a most effective advertisement, where advertisements appear relative to the remainder of the content, and when an advertisement has been viewed or otherwise consumed.

### BRIEF DESCRIPTION OF THE DRAWINGS

FIG. 1 is a simplified block diagram of a media distribution and gating management system implementing the methods and systems described herein.

FIG. 2 illustrates application of gates and scopes to an exemplary media item according to an embodiment of the present disclosure.

FIG. 3 illustrates a method according to an embodiment of the present disclosure.

FIG. 4 illustrates a method according to another embodiment of the present disclosure.

FIG. 5 is a functional block diagram of a client device according to an embodiment of the present invention.

### DETAILED DESCRIPTION

Embodiments of the present disclosure provide techniques for managing playback of media items in a computer system. A media item may include metadata that identifies portions of the media item as “gates,” that govern access to other portions of the media item, called “scopes.” When playback reaches a scope portion, a player may determine a state of its associated gate(s). If the gate is locked, the scope portion cannot be played until the gate is unlocked. When playback reaches a gate portion, the player may determine its state and either play the gate or skip playback of the gate depending on its state and definitions supplied for the gate. Gates may be collected into larger constructs, called “pools,” which may be locked and unlocked based on definitions supplied for the pools. The present disclosure describes a syntax from which content providers may define controls for the gates and scopes.

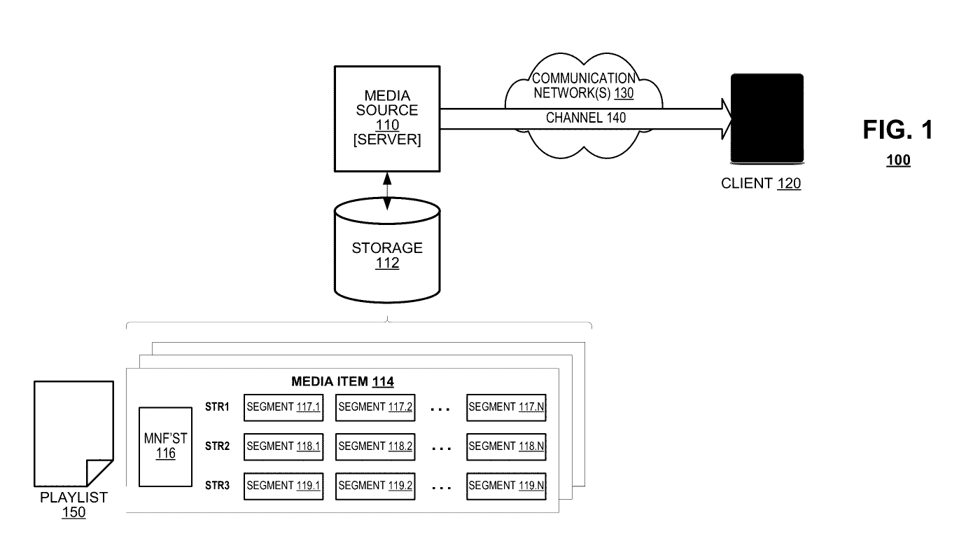

FIG. 1 illustrates a video delivery system 100 according to an embodiment of the present disclosure. The system 100 may include a media source 110 and a client device 120 connected via a communication network 130. The media source 110 may store video content and deliver it to client device 120 on request. The client 120 may consume media data and render it locally. The client 120 may initiate requests for the video content in response to operator controls and, once the client receives the video content from the media source 110, decode and play the received video content.

The media source 110 may include a server or network of servers (not shown) and a storage system 112 that stores one or more media items 114. The media items 114 represent content that can be downloaded and displayed by a client device 120. A media item 114 may include a manifest file 116, and coded video streams STR1, STR2, and STR3. The different streams STR1-STR3 may represent content of a common media item that has been coded according to different coding techniques. The streams STR1-STR3 may differ based on, for example, the protocol used to code the media item, the network data rates that are necessary to convey the streams between the media source 110 and a client 120, the frame sizes and/or frame rates of the video that each stream STR1-STR3 supports or the types of client device (e.g., smart phone vs. tablet computer vs. large screen projector) that the streams STR1-STR3 are intended to support. Typically, each stream may be stored as a plurality of individually-retrievable segments (e.g. STR1 as segments 117.1-117.N, STR2 as segments 118.1-118.N, etc.).

The manifest file 116 may store data describing the different streams that are available for retrieval. The manifest file 116 may describe parameters of the streams STR1-STR3 and network locations from which the corresponding segments 117.1-117.N, 118.1-118.N, and 119.1-119.N may be retrieved. In an embodiment, the manifest file 116 may store data defining gates as discussed herein.

The architecture of the media items 114 may be used both for pre-produced video that remains persistently stored at a media source and also for “live” streaming data, media that is captured, coded and distributed within the system 100 on a real time basis. For pre-produced data, a manifest file 116 and streams STR1-STR3 may be coded and stored by the storage system 112 with little or no alteration. For live streaming data, contents of the manifest file 116 and the streams STR1-STR3 may be provided on a rolling basis. The media source 110 may store data representing a predetermined portion of media (say a most recent 10 minute portions of the content), which is replenished on an ongoing basis and from which older portions of the content may be evicted. For the purposes of the present discussion, any distinction between pre-produced content and live streaming content is immaterial unless noted herein.

In an embodiment, the media source 110 may store a playlist 150 that identifies the media items that are available for download. In a simple implementation, a playlist 150 may identify media items 114 individually as single pieces of media content for consumption, say a video short. The principles of the present disclosure also find application with content applications that aggregate several media items into larger collections for consumption, for example, as a television program that integrates a video short with other media items. In such a case, the playlist 150 may identify the collection as single item of media content that, when played, would cause retrieval of several media items such as item 114. The principles of the present disclosure find application with such media items as well. In such an embodiment, metadata that defines gates may be provided within the playlist 150 rather than in the manifest file 116 of media items.

The client device 120 may include a media player to download, decode and display streaming media from the distribution server 110. As such, the client device 120 may include a video decoder (not shown) that decodes coded video data and a display device. The client device 120 also may include a processing system that may interpret gate definitions provided in metadata that accompanies a media item and applies access controls among portions of the media item as determined by those definitions. Although the client device 120 is illustrated as a tablet computer, it may be provided as a variety of computing platforms, including servers, personal computers, laptop computers, smart phones, media players and/or dedicated video conferencing equipment.

The network 130 represents any number of networks that convey coded video data among the media source 110 and client device 120, including, for example, wireline and/or wireless communication networks. A communication network 130 may exchange data in circuit-switched and/or packet-switched channels. Representative networks include telecommunications networks, local area networks, wide area networks and/or the Internet. For the purposes of the present discussion, the architecture and topology of the network 130 are immaterial to the present disclosure unless discussed hereinbelow.

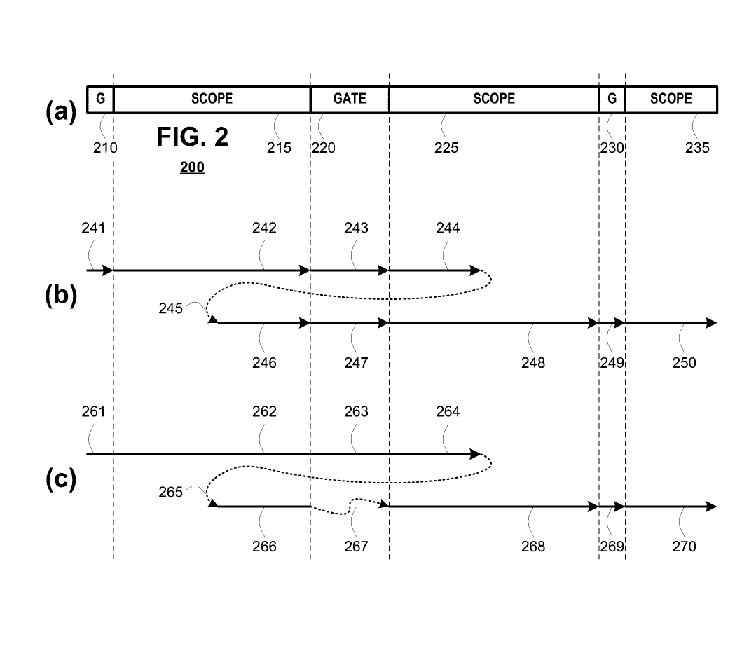

FIG. 2 illustrates an exemplary timeline of a media item 200 according to an embodiment of the present disclosure. The media item 200 may include two types of content. A “gate” represents an item of content whose state determines a level of access to be granted to another item of content, called the “scope” of the gate. A gate will be paired with a corresponding scope but some scopes need not be paired with a corresponding gate. A media item may have as many gates and scopes as may be desired to suit individual application needs. Thus, although three gates 210, 220 and 230 and three scopes 215, 235, 255 are illustrated in FIG. 2, other media items may have a greater number or a fewer number of gate-scope pairs than are illustrated.

Generally speaking, a gate 210 may govern access to a corresponding scope 215 within a media item. Thus, in an example where advertisements are provided as gates, a player may prevent playback of a given scope (say, scope 235) until the access requirements defined by its corresponding gate 230 are met. For example, the gate 230 may indicate that an advertisement must be played before playback may reach the scope 235.

In one embodiment, a gate may have one of two states: locked or unlocked. When a gate 230 is locked, its associated scope 235 may not be played. Such a gate 230 may become unlocked when its media is played. Thereafter, the media of scope 235 is played. Thus, locked gates effectively prevent a player from jumping around content of the gate and playing only the content of the scopes 215, 225, 235 within a media item.

In an embodiment, an unlocked gate may be replayed if it is encountered during playback. For example, FIG. 2(b) illustrates an exemplary playback sequence that might occur during playback of the media item 200. Playback may proceed through gate 210, scope 215 and gate 220 without interruption (segments 241-243). Although gates 210 and 220 initially may have locked their respective scopes 215, 225, the scopes 215, 225 may be unlocked once the gates 210, 220 are played. At some point during the playback of scope 225 (segment 244), playback may jump back to a position within scope 215 (shown as 245). The jump back would be permissible if the scope 215 were unlocked by the playing of gate 210 and, in this example, playback may resume normally following the jump (segment 246). When playback reaches the position of gate 220, the gate 220 may be replayed (segment 247) and, following gate 220, scope 225 may be replayed, also (segment 248). Thereafter, in this example, playback proceeds through the remainder of the media item 200 (segments 249-250).

In another embodiment, gates may have three states: locked, unlocked and collapsed. As before, locked gates prevent access to an associated scope and unlocked gates permit access to an associated scope. A collapsed gate also may permit access to an associated scope. Collapsed gates differ from unlocked gates, however, in the way they may be handled on repeat plays. An unlocked gate may be replayed if playback reaches it a second time whereas a collapsed gate need not be replayed.

FIG. 2(c) illustrates an example of playback where gate 220 is assumed to be a collapsible gate. Playback may proceed through gate 210, scope 215 and gate 220 without interruption (segments 261-263). Although gates 210 and 220 initially may have locked their respective scopes 215, 225, the scopes 215, 235 may be unlocked once the gates 210, 220 are played. At some point during the playback of scope 225 (segment 264), playback may jump back to a position within scope 215 (shown as 265). The jump back would be permissible if the scope 215 were unlocked by the playing of gate 210 and, in this example, playback may resume normally following the jump (segment 266). When play back reaches the position of gate 220, the gate 220 may be identified as having a collapsed state. Playback may jump from an end of scope 215 to a beginning of scope 225 (shown as 267). The content of the collapsed gate 220 need not be replayed. Thereafter, in this example, playback proceeds through the remainder of the media item 200 (segments 268-270).

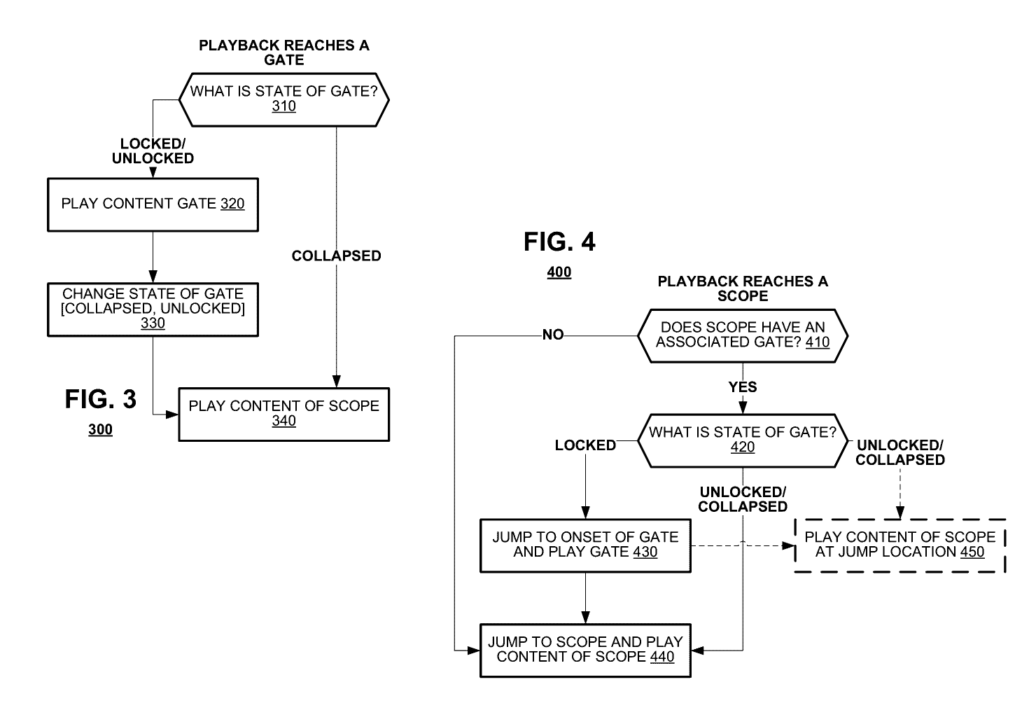

FIG. 3 illustrates a method 300 according to an embodiment of the present disclosure. The method 300 may be invoked when playback reaches a gate within a media item's presentation timeline. The method 300 may determine the state of the gate (box 310). If the gate is either locked or unlocked, the method 300 may play content of the gate (box 320). At some point during playback of the gate, a gate unlock condition may be met (step not shown). When the unlock condition is met, the method may change the state of the gate to either unlocked or collapsed as defined for the gate (box 330). The unlock condition may be defined based on playing through a gate once, playing through the gate a predefined number of times, or according to other conditions. In an embodiment, at some point after box 330, playback may reach the end of the gate and playback may commence with the scope (box 340). In an alternative embodiment, playback may reach the end of the gate without subsequently playing the scope (step not shown). At box 310, if the state of the gate is set to collapsed, then playback may jump to the onset of the succeeding scope (box 340). In an embodiment, if the state of the gate is set to unlocked, a player can fast forward, re-wind, jump forward, or jump backward while playing the gate.

FIG. 4 illustrates a method 400 according to another embodiment of the present disclosure. The method 400 may be invoked when playback reaches a scope within a media item's presentation timeline. The method 400 may determine whether the scope has an associated gate (box 410). If so, the method 400 may determine the state of the gate (box 420). If the gate's state is locked, the method 400 may jump to the onset of the gate and begin playback of the gate (box 430). Thereafter, if playback of the gate causes the gate's state to change to unlocked or collapsed, the method 400 may play content of the scope (box 440). If, at box 420, the method 400 determined that the gate's state was either unlocked or collapsed, the method may advance to box 440 and play content of the scope.

The method 400 of FIG. 4 may be performed when playback reaches a scope through any means, whether by ordinary playback or trickplay (e.g., a jump to a position within a scope). In an embodiment, if the scope is reached by a jump, playback of the scope may commence from the jump location when the gate's state is either unlocked or collapsed (box 450). Further, after playback of the gate in box 430, playback may jump to the jump location rather than commence from a start position of the scope.

Embodiments of the present disclosure provide a suite of tools that allows content publishers to define gates with a variety of different access parameters. These tools may permit content developers to define, for example, which elements in a media timeline are controlled by a gate, whether a gate must be played anew each time its scope is to be played, and how to handle trickplay events (e.g., scrubbing/scanning along a timeline, jumps between locations of the timeline, etc.).

Table 1 illustrates a set of attributes that may be used to define a gate in an embodiment of the present invention. Gates may be defined in metadata that accompanies a media item.

TABLE 1

| SYNTACTIC ELEMENT | ASSOCIATED FUNCTION |
|---|---|
| gate-time | A time that the gate starts, e.g., an offset in seconds from a |
| | beginning of a video segment. |
| gate-date | A date and/or time at which the gate begins, with reference to a |
| | standard time reference within a network. |
| gate-duration | A duration or length of the gate. |
| gate-id | An identification of the gate, which may be unique with respect |
| | to the timeline and referenced by a state record. |
| gate-allows-ff | Whether a player can fast forward while playing a locked gate. |
| | This attribute may be set to a default value (such as false) if the |
| | attributed is omitted from a gate definition. |
| gate-allows-rw | Whether a player can rewind while playing a locked gate. |
| | This attribute may be set to a default value (such as false) if the |
| | attributed is omitted from a gate definition. |
| gate-allows-jump-forward | Whether a player can jump forward while playing a locked gate. |
| | This attribute may be set to a default value (such as false) if the |
| | attributed is omitted from a gate definition. |
| gate-allows-jump-backward | Whether a player can jump backward while playing a locked |
| | gate. |
| | This attribute may be set to a default value (such as false) if the |
| | attributed is omitted from a gate definition. |
| gate-allows-pause | Whether a player can pause (and resume) while playing a locked |
| | gate. |
| | This attribute may be set to a default value (such as true) if the |
| | attributed is omitted from a gate definition. |
| gate-unlocks-at | Time at which a gate is unlocked or duration after which a gate is |
| | unlocked. |
| collapse-on-unlock | Whether a gate and/or pool is collapsed when it unlocks. |
| gate-is-global | Whether a gate has global scope. |
| gate-grace-period | Indicates that gate is unlocked until content-played-since-gate |
| | reaches this duration, at which point it will be locked. |
| gate-consumed-at | A point at which a gate is considered to be consumed. |
| gate-value | A value of consuming the gate. |
| pool-skip-value | A minimum value of a pool to permit unlocking. May be in terms |
| | of a number of gates consumed. |
| pool-counts-replays | Whether replays of a gate are counted towards a gate value. |
| if-scan-forward | Allows provision of alternate values for attributes when scanning |
| | forward. |
| if-scan-backward | Allows provision of alternate values for attributes when scanning |
| | backward. |
| if-jump-ahead | Allows provision of alternate values for attributes when jumping |
| | ahead. |
| if-jump-behind | Allows provision of alternate values for attributes when jumping |
| | behind. |
| timeline | An array of objects on the timeline. |
| schema-version | A version of the schema according to which a rule layout is |
| | authored. May provide compatibility with various new schema, |
| | e.g., backwards compatibility with older versions of a schema. |

The example of Table 1 illustrates syntactic elements using JavaScript Object Notation but such elements may employ alternate notations, if desired for a given application.

As shown above, gates may be defined by their start times and durations. The start times may be expressed either as an offset into the media item's timeline, which may be convenient for pre-produced media items, or with reference to a defined timing reference within a network, which may be convenient for live streamed data. For example, several networking protocols define clock references for networked elements, including the Network Time Protocol (NTP), IEEE 1588 and IEEE 802.1 as standards. Gates for live streamed data may be defined with reference to times defined by any of these standards.

The following examples may help to explain the syntactic elements illustrated in Table 1.

### EXAMPLE 1

{

“timeline” :
[

{

“type” : “gate”,
“gate-time” : 0.0,
“gate-duration” : 30.0,

},
{

“type” : “gate”,
“gate-time” : 600.0,
“gate-duration” : 30.0,
“gate-unlocks-at” : 15.0,

},

],

}

In this example, the onset of the first gate is defined to begin at the onset of the media item (time=0.0 sec) and have a duration of 30.0 seconds. The onset of the second gate is defined to begin 10 minutes into the media item (time=600.0 sec) and also have a duration of 30.0 seconds. The second gate is defined to unlock at 15 seconds, which means it will unlock its corresponding scope if the gate is played for 15 seconds, even if an operator jumps out of the gate at some point thereafter. In an alternative embodiment, a scope may be controlled by more than one gate. Accessing the scope may be conditioned upon playback of the controlling gates. For example, playback may proceed from a first gate to a second gate before jumping to content of the associated scope.

### EXAMPLE 2

{

“gate-duration” : 15.0,
“timeline” :
[

{

“type” : “gate”,
“gate-date” : 2014-8-21T11:10:08.02-08:00

},
{

“type” : “gate”,
“gate-date” : 2014-8-21T11:12:42.57-08:00

}

]

}

In this example, the gate-duration definition precedes the timeline marker, which may indicate that the gate-duration is a global parameter that can be applied to all gates within the timeline, unless overridden by an occurrence of gate-duration in another gate definition. In example 1, the gate-duration value appeared for each of the gate definitions in the body of the timeline. Those gate-duration definitions, therefore, applied only to the gates to which they are associated.

In example 2, each instance of the gate-date field identifies a network time on which the respective gates begin. This embodiment finds application in a live streaming implementation where gates are applied to scopes that are distributed as they are produced.

### EXAMPLE 3

{

″gate-duration″ : 30.0,
″collapse-on-unlock″ : ″true″,
″timeline″ :
[

{

″type″ : ″gate″,
″gate-time″ : 0.0

},
{

″type″ : ″gate″,
″gate-time″ : 255.0
“gate-duration” : 15.0

}

]

}

In example 3, all gates are defined to have a default duration of 30 seconds but the second gate includes a gate-duration (15 seconds) that overrides the default duration. Moreover, all gates are defined to be collapsible when they are unlocked. As in FIG. 1(c), if playback returns to a gate that has been played already, the gate itself will not be replayed and playback will jump to the scope to which it corresponds.

### EXAMPLE 4

{

“gate-duration” : 30.0,
“gate-unlocks-at” : 1000.0,
“timeline” :
[

{

“type” : “pool”,
“pool-skip-value” : 3,
“gates” :
[

{

“type” : “gate”,
“gate-time” : 0.0

},
{

“type” : “gate”,
“gate-time” : 30.0

},
{

“type” : “gate”,
“gate-time” : 330.0

},
{

“type” : “gate”,
“gate-time” : 660.0

}

]

}

]

}

In example 4, all gates are defined to have a default duration of 30 seconds. The gate-unlocks-at value is set to 1000 seconds, which causes the gates to unlock once they are played for 1000 seconds or at their conclusion, whichever is shorter. In this example, because the default duration is 30 seconds, the gates will unlock at 30 seconds. In one aspect, it may be advantageous to set the gate-unlocks-at value higher than the gate-duration value if a largest duration of that a subsequent gate is unknown or uncertain.

Example 4 also employs a pool attribute, which allows content providers to define relationships among gates assigned to a common pool. For example, for any pool that is unlocked, all gates in the pool may be treated as unlocked, regardless of their per-gate rule evaluation. Similarly, for any pool that is collapsed, all gates in the pool may be treated as collapsed, regardless of their per-gate rule evaluation. For any pool that is locked, each gate in the pool obeys its own lock evaluation.

In Example 4, the pool-skip-value is set to 3, which causes all gates in the pool to be unlocked once three gates have been unlocked. Since the gate-unlocks-at value is set higher than the gate-duration in this example, the pool will be unlocked once three gates have been played in their entirety.

### EXAMPLE 5

{

“gate-duration” : 30.0,
“gate-grace-period” : 5.0,
“timeline” :
[

{

“type” : “gate”,
“gate-time” : 0.0

},
{

“type” : “gate”,
“gate-time” : 330.0

},
{

“type” : “gate”,
“gate-time” : 660.0

}

]

}

In this example, the gate-grace-period is set to 5 seconds. This field indicates that the gates will be unlocked until a content-played-since-gate reaches 5 seconds, which is reached when the player is in a normal playback mode (e.g., not fast-forward or fast-reverse) and has gone at least 5 seconds since playing a gate. This mode permits viewers to preview a portion of a scope before requiring playback of a gate.

Gate definitions also may constrain a client's response to user playback commands.

For example, the “gate-allows-if,” “gate-allows-rw,” “gate-allows-jump-forward,” “gate-allows-jump-backward” and “gate-allows-pause” parameters may dictate to a client its response when a user attempts to terminate ordinary playback in favor of an alternate viewing mode while playing content of a gate. Similarly, the “if-scan-forward,” “if-scan-backward,” “if-jump-ahead” and “if-jump-behind” parameters may dictate to a client its response when a user attempts to engage alternate viewing modes while playing content of a scope.

Gate definitions also may constrain a client's response to user playback commands. For example, the “gate-allows-if,” “gate-allows-rw,” “gate-allows-jump-forward,” “gate-allows-jump-backward” and “gate-allows-pause” parameters may dictate to a client its response when a user attempts to terminate ordinary playback in favor of an alternate viewing mode while playing content of a gate. Similarly, the “if-scan-forward,” “if-scan-backward,” “if-jump-ahead” and “if-jump-behind” parameters may dictate to a client its response when a user attempts to engage alternate viewing modes while playing content of a scope.

In an embodiment, a client, e.g., a playback service, may develop a state record that reflects its usage of the gates within a media item. For example, for each gate that is played-through, the client may store data identifying the maximum gate duration the user has watched and update the state record. Thus, individual gates in a media item may be marked with a gate-id and the state record may associate each gate's usage with these gate-ids.

In an embodiment, a state record may have a layout as follows:

{

| “last-modified” : <ISO-8601 date>, | |
|---|---|
| “content-played” : <duration>, | // where duration |

represents amount of time that non-gate content has been played at rate
1.0.

| | |
|---|---|
| “content-played-since-gate” : <duration>, | // where duration |

represents amount of time that non-gate content has been played at rate
1.0 since a gate was last played.

“timeline-status” :
[

| | |
|---|---|
| { | // these timeline status elements map one-to-one with the |

timeline elements in the gate definition

| “type” : “gate”, | |
|---|---|
| “gate-time” : <time>, | // follows the gate |

definition, e.g., using either gate-time or gate-date

| | |
|---|---|
| “gate-played” : <duration>, | // indicates |

the furthest point into a gate that has been played continuously at rate 1.0
from its start.

| | |
|---|---|
| “gate-consumed: : <integer>, | // number of times |

the gate has been consumed.

| | |
|---|---|
| “has-collapsed: : <boolean>, | // true if the gate |

or pool has collapsed.

| | |
|---|---|
| “gate-id” : <string>, | // matches gate |
| | definition. |

},
{

| | |
|---|---|
| “type” : “pool”, | // matches gate definition |

“has-collapsed: : <boolean>,
“gates” :
[

{

| “type” : “gate”, | |
|---|---|
| “gate-time” : | // see above |
| <time>, | |
| “gate-played” : | // see above |
| <duration>, | |
| “gate-consumed: : | // see above |
| <integer>, | |
| “has-collapsed: : | // see above |
| <boolean>, | |
| “gate-id” : | // see above |
| <string>, | |

},

],

},

]

}

In implementation, the exact form of a state record will be determined by the gate definitions that are provided for a media item.

Returning to FIG. 1, the principles of the present disclosure find application with a variety of distribution systems. As illustrated in FIG. 1, a single media item 114 may be stored as a plurality of coded media streams STR1-STR3, each representing content of the media item but in a different representation. The streams may be parsed into a plurality of individually downloadable segments 117.1-117.N, 118.1-118.N, and 119.1-119.N. In this manner, a client device 120 may switch among the different streams STR1-STR3 dynamically in response to resource limitations that may arise, either due to network events or due to resource limitations at the client device itself. Even as the client device 120 switches among the streams, the segments that it downloads may conform to a common media timeline and, therefore, the client device may conform its operation to the dictates of gate definitions. In such an application, client management of access controls imposed by gate definitions need not change regardless of whether the client downloads segments 117.1-117.N from a single stream STR1 throughout playback of a media item 114 or whether it switches among segments of multiple streams STR1-STR3.

The principles of the present disclosure also find application in distribution systems that employ proxy caches and the like. Although not illustrated in FIG. 1, the media source 110 may be replicated across a wide area network such as the Internet. In such applications, it may occur that some elements of a media item 114 (say, a first number of segments) may be furnished from a server at one location on the network whereas other elements of the media item 114 (a second number of segments) may be furnished by another server at a different location on the network. For the purposes of the present discussion, it is unimportant where the segments originate so long as the client device 120 can relate the segment to a common media timeline.

The principles of the present disclosure, of course, find application with distribution systems in which a media item 114 is a unitary file (not shown), without use of streams as illustrated in FIG. 1. In such a case, the unitary file conforms to a single media time line to which gate definitions may be applied readily.

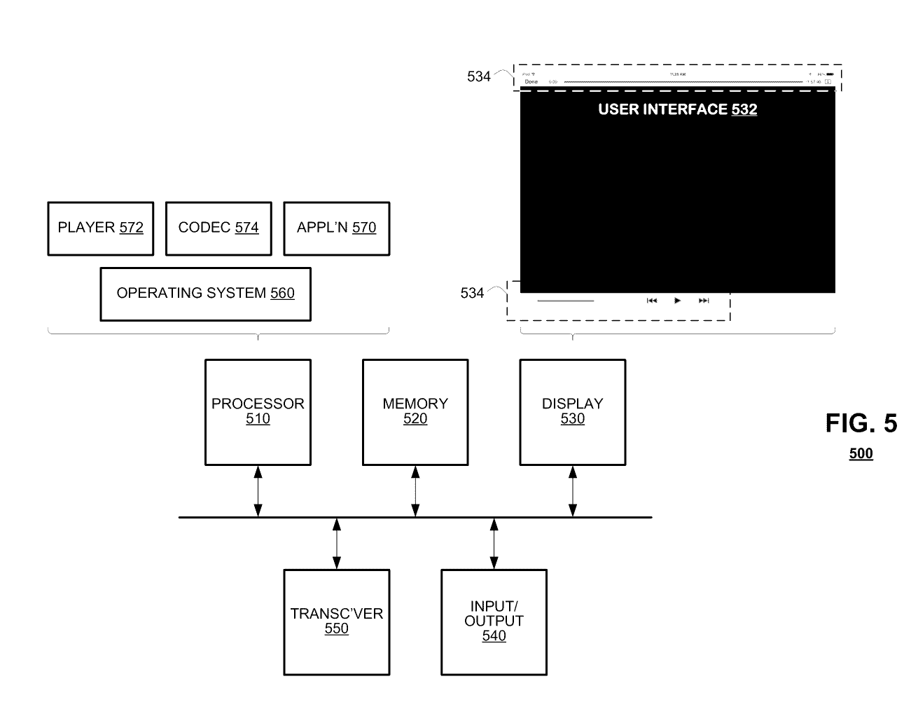

FIG. 5 is a functional block diagram of a client device 500 according to an embodiment of the present invention. The client device may include a processor 510, a memory system 520, display 530, input/output system 540 and transceiver 550. The memory system 520 may store instructions that define an operating system 560, application programs and application data (collectively “applications”) 570 within the terminal 500. One such application may be a video player 572 that renders media items on a display 530 of the client device 500. Another application may be a video codec 574 that decodes coded media items received from a media source (FIG. 1). The video codec 574 typically operates according to a standard decoding protocol such as ITU H.263, H.264 and/or H.265.

The display 530 may include a display device and associated driver circuitry, including graphics processors and associated memories (not shown). The display 530 may output a user interface 532 that is generated by the processor 510, which may include various user controls 534 for altering playback, including trickplay modes such as scrubbing, jumps, fast forward and fast reverse playback. As discussed, the client device 500 may disable various playback modes as dictated by gate definitions. In doing so, the client device 500 may alter the user interface to present or remove select playback controls depending on which playback modes are authorized or disabled by the gate definitions.

The input/output system 540 may represent a suite of controls through which an operator may enter commands to the device. The client device 520 may include an array of buttons, keyboard, mice and/or touchscreen devices for entry of such commands. The nature of such input device may be tailored to fit the type of client device 500 in which the principles of the present disclosure are applied. For example, as illustrated in the user interface 532 of FIG. 5, a tablet computer may include relatively few buttons and provide graphical controls in conjunction with a touch screen device. A notebook computer by contrast may include a keyboard and mouse in addition to graphical controls provided via a user interface 532.

The transceiver 550 may support communication between the client device 500 and a communication network (FIG. 1). The transceiver 550 may include one or more communication devices such as wireline and or wireless transmitters for connection to wired and wireless networks, respectively.

Although FIG. 5 illustrates the codec 574 as an application program that is executed by the processor 510, other implementations permit the codec to be implemented as an integrated circuit separate from the processor 510 (not shown). For example, the codec may be implemented as a digital signal processor or application specific integrated circuit.

Although the foregoing description includes several exemplary embodiments, it is understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular means, materials and embodiments, the disclosure is not intended to be limited to the particulars disclosed; rather the disclosure extends to all functionally equivalent structures, methods, and uses such as are within the scope of the appended claims.

As used in the appended claims, the term “computer-readable medium” may include a single medium or multiple media, such as a centralized or distributed database, and/or associated caches and servers that store one or more sets of instructions. The term shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

The present specification describes components and functions that may be implemented in particular embodiments which may operate in accordance with one or more particular standards and protocols. However, the disclosure is not limited to such standards and protocols. Such standards periodically may be superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

For example, operation of the disclosed embodiments has been described in the context of servers and terminals that implement video compression, coding, and decoding. These systems can be embodied in electronic devices or integrated circuits, such as application specific integrated circuits, field programmable gate arrays and/or digital signal processors. Alternatively, they can be embodied in computer programs that execute on personal computers, notebook computers, tablets, smartphones or computer servers. Such computer programs typically are stored in physical storage media such as electronic-, magnetic- and/or optically-based storage devices, where they may be read to a processor, under control of an operating system and executed. And, of course, these components may be provided as hybrid systems that distribute functionality across dedicated hardware components and programmed general-purpose processors, as desired.

In addition, in the foregoing Detailed Description, various features may be grouped or described together the purpose of streamlining the disclosure. This disclosure is not to be interpreted as reflecting an intention that all such features are required to provide an operable embodiment, nor that the claimed embodiments require more features than are expressly recited in each claim. Rather, as the following claims reflect, subject matter may be directed to less than all of the features of any of the disclosed embodiments. Thus, the following claims are incorporated into the Detailed Description, with each claim standing on its own as defining separately claimed subject matter.

Also, where certain claims recite methods, sequence of recitation of a particular method in a claim does not require that that sequence is essential to an operable claim. Rather, particular method elements or steps could be executed in different orders without departing from the scope or spirit of the invention.

What is claimed is:

1. A video playback method, comprising:
parsing a media item into gates and associated scopes,
when playback reaches a gate portion of the media item, determining the gate's state,
if the gate's state is collapsed, advancing playback to a scope portion of the media item associated with the gate, and playing the scope portion,
otherwise, playing content of the gate portion before playing the scope portion.

2. The method of claim 1, further comprising, when a gate unlock condition is met while playing content of the gate portion, changing the state of the gate to unlocked for another iteration of operation.

3. The method of claim 2, wherein, when the gate unlock condition is met, changing the state of the gate to collapsed.

4. The method of claim 1, further comprising, when a gate unlock condition is met while playing content of the gate portion:
determining whether the gate is a member of a pool of gates,
if so, determining whether a pool unlock condition is met, and
if so, changing a state of all gates in the pool to one of: unlocked and collapsed.

5. The method of claim 1, wherein the parsing occurs based on gate definitions provided in metadata associated with the media item.

6. The method of claim 5, wherein the gate definitions include a value identifying a content period of the gate from a start position of the media item and a duration value.

7. The method of claim 5, wherein the gate definitions include a value identifying a network time of an onset of the gate from a network time and a time offset from the network time.

8. The method of claim 5, further comprising:
responsive to a command to alter gate playback from a normal mode to an alternate viewing method, determining from the gate definitions whether the alternate viewing mode is enabled, and
if the alternate viewing mode is enabled, engaging the alternate viewing mode.

9. The method of claim 5,wherein the gate definitions include a grace period, the gate being unlocked during the grace period and locked thereafter.

10. The method of claim 5, wherein the gate definitions include a value identifying whether a gate is global, attributes of a global gate overriding attributes of a local gate.

11. The method of claim 5, wherein the gate definitions include a value defining a time at which a gate is consumed.

12. The method of claim 5, wherein properties controlling behavior of the gate varies based on a point of playback being reached via a normal mode or an alternate viewing mode.

13. The method of claim 5, wherein at a least a portion of playback activity is mapped to state record information, the mapping being applicable to a playback device to restore a state of gates.

14. A video playback method, comprising:
parsing a media item into gates and associated scopes,
playing content of a gate portion of the media item,
responsive to a user command to exit the gate, determining the gate's state,
if the gate's state is unlocked, advancing playback to a scope portion of the media item associated with the gate and playing the scope portion,
otherwise, continuing playing content of the gate portion.

15. The method of claim 14, further comprising, when a gate unlock condition is met, changing the state of the gate to unlocked.

16. The method of claim 14, further comprising, when a gate unlock condition is met, changing the state of the gate to collapsed.

17. The method of claim 14, further comprising, when a gate unlock condition is met:
determining whether the gate is a member of a pool of gates,
if so, determining whether a pool unlock condition is met, and
if so, changing a state of all gates in the pool to unlocked.

18. The method of claim 14, wherein the parsing occurs based on gate definitions provided in metadata associated with the media item.

19. The method of claim 18, wherein the gate definitions include a value identifying an onset of the gate from a start position of the media item and a duration value.

20. The method of claim 18, wherein the gate definitions include a value identifying a network time of an onset of the gate from a start position of the media item and a duration value.

21. A video playback method, comprising:
parsing a media item into gates and associated scopes,
when playback reaches a scope portion of the media item, determining a state of a gate item associated with the scope portion,
if the gate's state is unlocked, playing the scope portion,
otherwise, playing content of the gate portion before playing the scope portion.

22. The method of claim 21, wherein the playback reaches the scope portion in a normal playback mode.

23. The method of claim 21, wherein the playback reaches the scope portion in a jump within a media item timeline.

24. The method of claim 21, further comprising:
maintaining a running count of an elapsed time of normal playback that occurs without playback of a gate,
when the running count meets a triggering condition, setting a state of another gate in playback order to locked,
otherwise, setting the state of the other gate to unlocked.

25. A video playback apparatus, comprising:
a video decoder to decode a coded media item, and
a processor to:
parse the media item into gates and associated scopes,
when playback reaches a scope portion of the media item, determine a state of a gate item associated with the scope portion,
if the gate's state is unlocked, play the scope portion to a display, and
otherwise, play content of the gate portion to the display before playing the scope portion.

26. The apparatus of claim 25, wherein the processor further:
maintains a running count of an elapsed time of normal playback that occurs without playback of a gate,
when the running count meets a triggering condition, sets a state of a next gate in playback order to locked,
otherwise, sets the state of the next gate to unlocked.

27. The apparatus of claim 25, wherein the processor changes a state of the gate to unlocked when a gate unlock condition is met.

28. The apparatus of claim 25, wherein the processor changes a state of the gate to collapsed when a gate unlock condition is met.

29. The apparatus of claim 25, wherein, when a gate unlock condition is met, the processor:
determines whether the gate is a member of a pool of gates,
if so, determines whether a pool unlock condition is met, and
if so, changes a state of all gates in the pool to unlocked.

30. A non-transitory computer-readable medium storing program instructions that, when executed, cause a processor to perform a method, the method comprising:
parsing a media item into gates and associated scopes,
when playback reaches a gate portion of the media item, determining the gate's state,
if the gate's state is collapsed, advancing playback to a scope portion of the media item associated with the gate, and playing the scope portion,
otherwise, playing content of the gate portion before playing the scope portion.

31. A non-transitory computer-readable medium storing metadata and a media item that when played by a video player, cause the player to perform a method, the method comprising:
parsing the media item into gates and associated scopes according to the metadata,
when playback reaches a gate portion of the media item, determining the gate's state,
if the gate's state is collapsed, advancing playback to a scope portion of the media item associated with the gate, and playing the scope portion,
otherwise, playing content of the gate portion before playing the scope portion.

32. The method of claim 1, wherein the playing content of the gate portion includes playing content of a plurality of gates.

33. The method of claim 1, wherein the parsing occurs based on gate definitions supplied by a client.

34. The method of claim 2, wherein, in a subsequent iteration of operation, the unlocked gate is skippable responsive to a received command.
